(19) United States
(12) Patent Application Publication
(10) Pub. No.: US 2024/0402396 A1
(43) Pub. Date: Dec. 5, 2024

(54) LENS ARRAY AND METHOD OF FABRICATING THE SAME

(71) Applicant: SAMSUNG DISPLAY CO., LTD., Yongin-si (KR)

(72) Inventor: Rang Kyun MOK, Yongin-si (KR)

(21) Appl. No.: 18/609,948

(22) Filed: Mar. 19, 2024

(30) Foreign Application Priority Data
May 30, 2023 (KR) 10-2023-0069475

(51) Int. Cl. G02B 3/00; G02B 5/04

(52) U.S. Cl. CPC G02B 3/005; G02B 3/0012; G02B 5/045

(57) ABSTRACT

A lens array includes a base substrate, a plurality of prisms arranged in parallel to each other in a first direction on the base substrate, and a plurality of lenses covering the plurality of prisms, and arranged parallel to each other in the first direction. Each of the prisms and each of the lenses extends in a second direction different from the first direction.

### CROSS-REFERENCE TO RELATED APPLICATION

The present application claims priority to Korean patent application number KR 10-2023-0069475, filed on May 30, 2023, the entire disclosure of which is herein incorporated by reference in its entirety.

### TECHNICAL FIELD

Various embodiments of the present disclosure relate to a lens array and a method of fabricating the lens array.

### DISCUSSION OF THE RELATED ART

With the development of information technology, the importance of a display device, which is a device for displaying information to a user, has been emphasized. Owing to the importance of display devices, the use of various kinds of display devices, such as a liquid crystal display (LCD) device and an organic light-emitting diode (OLED) display device, has increased.

A stereoscopic image display device is a display device which provides separate left-eye and right-eye images so as to provide the viewer with a sense of depth by binocular parallax between the left and right eyes.

Stereoscopic image display devices traditionally relied upon the use of special stereoscopic glasses that ensure each eye of the viewer receives only the corresponding image. Recently, studies on a glassless method in which stereoscopic glasses are not used have been actively conducted. Some such approaches utilize a lenticular method in which left and right eye images are separated using a cylindrical lens array, and a barrier method in which left and right eye images are separated using a barrier.

A display device using a glassless method may form a light field including a plurality of viewpoints. In this case, crosstalk may occur in such a way that each of the viewpoints partially overlaps adjacent viewpoints.

### SUMMARY

A lens array includes a base substrate, a plurality of prisms arranged in parallel to each other in a first direction on the base substrate, and a plurality of lenses covering the plurality of prisms, and arranged in parallel to each other in the first direction. Each of the plurality of prisms and each of the plurality of lenses extend in a second direction different from the first direction.

A first surface of each of the plurality of prisms may contact an upper surface of the base substrate. A second surface and a third surface of each of the plurality of prisms may contact inner surfaces of each of the plurality of lenses. The first surface, the second surface, and the third surface may extend in the second direction.

The base substrate and the plurality of prisms may have an identical first refractive index.

The plurality of lenses may have a second refractive index that is less than the first refractive index.

The second refractive index may be greater than a third refractive index that is equal to a refractive index of air.

Internal angles of a cross-section of each of the plurality of prisms may be identical to each other.

Among internal angles of a cross-section of the plurality of prisms, the internal angle that abuts the base substrate may be less than the internal angle that does not abut the base substrate.

Among internal angles of a cross-section of the plurality of prisms, the internal angle that abuts the base substrate may be greater than the internal angle that does not abut the base substrate.

An apex of each of the plurality of prisms may have a curved shape.

A cross-section of each of the plurality of prisms may include a trapezoidal base, and a semi-circular apex.

A lens array includes a base substrate having a planar shape extending in a first direction and a second direction perpendicular to the first direction, a plurality of pyramids disposed on the base substrate, and a plurality of lenses, each of which covering a corresponding pyramid of the plurality of pyramids.

A rectangular base of each of the plurality of pyramids may contact the base substrate. An apex of each of the plurality of pyramids may protrude in a third direction perpendicular to the first direction and the second direction.

The base substrate and the plurality of pyramids may have an identical first refractive index.

The plurality of lenses may have a second refractive index that is smaller than the first refractive index.

The second refractive index may be greater than a third refractive index that is equal to a refractive index of air.

A method of fabricating a lens array includes preparing a base substrate, forming a plurality of prisms arranged parallel to each other in a first direction on the base substrate, and forming a plurality of lenses covering the plurality of prisms, and arranged parallel to each other in the first direction. Each of the plurality of prisms and each of the plurality of lenses extends in a second direction different from the first direction.

The base substrate and the plurality of prisms may have an identical first refractive index.

The plurality of lenses may have a second refractive index that is smaller than the first refractive index.

The second refractive index may be greater than a third refractive index that is equal to a refractive index of air.

Among internal angles of a cross-section of the plurality of prisms, the internal angle that abuts the base substrate may be less than the internal angle that does not abut the base substrate.

### BRIEF DESCRIPTION OF THE DRAWINGS

FIG. 1 is a diagram illustrating a lens array-type stereoscopic image display device.

FIG. 2 is a diagram illustrating a relationship between a lens array and a display panel in accordance with an embodiment of the present disclosure.

FIGS. 3 to 5 are diagrams illustrating a method of fabricating the lens array in accordance with an embodiment of the present disclosure.

FIG. 6 is a diagram illustrating effects of the lens array in accordance with an embodiment of the present disclosure.

FIGS. 7 to 9 are diagrams illustrating lens arrays in accordance with embodiments of the present disclosure.

FIGS. 10 and 11 are diagrams illustrating a case where the present disclosure is applied to different types of lens arrays.

### DETAILED DESCRIPTION

Hereinafter, embodiments of the present invention will be described in detail with reference to the attached drawings. The present disclosure may be implemented in various forms, and is not necessarily limited to the embodiments to be described herein below.

In the drawings, various elements may be omitted in order to provide a clearer disclosure. Reference should be made to the drawings, in which similar reference numerals are used throughout the different drawings to designate similar components. Therefore, the aforementioned reference numerals may be used in other drawings.

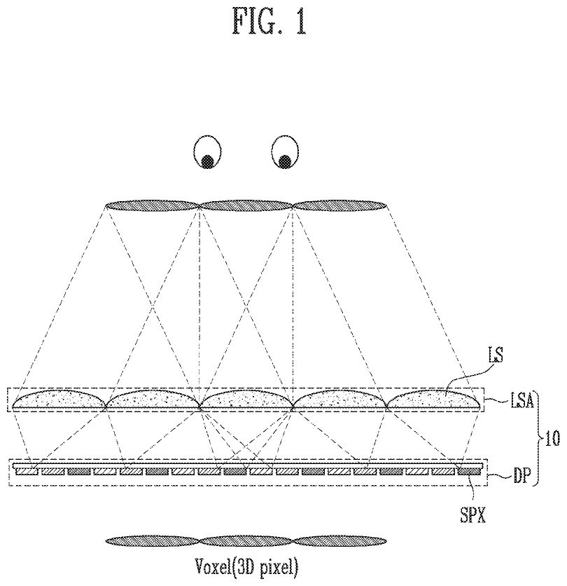

FIG. 1 is a diagram illustrating a lens array-type stereoscopic image display device.

Referring to FIG. 1, the display device 10 may include a display panel DP and a lens array LSA.

The display panel DP may include various sub-pixels SPX which emit light to display an image. In an embodiment, each of the sub-pixels SPX may emit one among light of a first color (e.g., red), light of a second color (e.g., green), and light of a third color (e.g., blue). However, the foregoing is merely illustrative, and the colors of light emitted from the sub-pixels SPX are not necessarily limited thereto, and various colors of light may be outputted to implement a full-color image. The display panel DP may include an organic light emitting diode (OLED) display panel, a liquid crystal display (LCD) panel, a quantum dot display panel, or the like.

The lens array LSA may be disposed on the display panel DP, and may include lenses LS that refract light that is incident thereon from the sub-pixels SPX. For example, the lens array LSA may be implemented as a lenticular lens array, a micro lens array, or the like.

A light field display is a 3D display device which forms a light field expressed by vector distribution (e.g., intensity, direction) of light on a space using a flat panel display and an optical element (e.g. a lens array LSA) to embody a stereoscopic image. The light field display pertains to a display technology which is expected to be used in various applications by fusion with an AR (augmented reality) technology, and the like, because the light field display allows a user to recognize the depth of a target object and see a side surface of the target object and thus can embody a more natural stereoscopic image.

The light filed may be implemented in various ways. For example, the light field may be formed by making a multi-directional light field using multiple projectors, by controlling the direction of light using a diffraction grating, by controlling the direction and intensity (e.g., luminance) of light according to the combination of each pixel using two or more panels, by controlling the direction of light using a pinhole or a barrier, or by controlling the refraction direction of light through the lens array, or the like.

In an embodiment, as illustrated in FIG. 1, the lens array-type stereoscopic image display device 10 may display a stereoscopic image (e.g., a 3D image) by forming the light field.

A series of sub-pixels SPX may be allocated to each lens LS, and light emitted from each of the sub-pixels SPX may be refracted by the lens LS so as to travel only in a specific direction, thus forming a light field expressed by the intensity and direction of light. When a viewer looks at the display device 10 in the light field formed by the foregoing method, the viewer can perceive a three-dimensional effect of a corresponding image.

Image information, according to a viewpoint of the viewer in the light field, may be defined and processed on a voxel basis. The voxel may be understood as graphic information defining a certain point (or pixel) in a 3D space.

The resolution of a two-dimensional (2D) image may be determined as the number of pixels per unit area (e.g., density). For example, in the case where the number of pixels per unit area increases, the resolution may increase. For example, a display panel DP having a relatively high pixel density may be needed to provide a high resolution image. Likewise, if the number of voxels at the same viewpoint is increased by the lens array LSA, the resolution of a stereoscopic image may be increased.

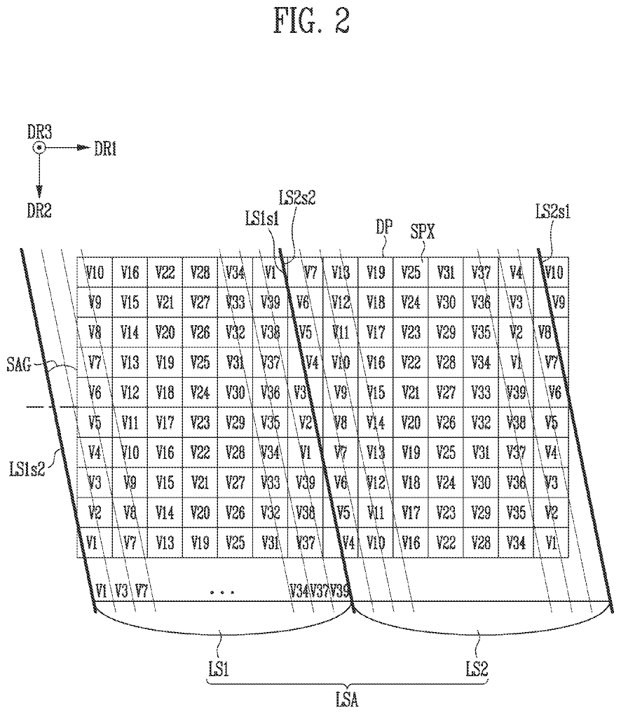

FIG. 2 is a diagram illustrating a relationship between the lens array LSA and the display panel DP.

The display panel DP may include sub-pixels SPX arranged in a first direction DR1 and a second direction DR2 perpendicular to the first direction DR1. The sub-pixels SPX may include emission surfaces in a third direction DR3 perpendicular to the first direction DR1 and the second direction DR2.

The lens array LSA may include lenses LS1, LS2, . . . . The lenses LS1, LS2, . . . may overlap the sub-pixels SPX in the third direction DR3. The lenses LS1, LS2, . . . may be arranged in such a way that each long side thereof has an angle SAG greater than 0° (degrees) with respect to the second direction DR2. For example, the lenses LS1, LS2, . . . may be lenticular lenses. For example, the first lens LS1 may include a first long side LS1s1 and a second long side LS1s2 which are parallel to each other. Furthermore, the second lens LS2 may include a first long side LS2s1 and a second long side LS2s2 which are parallel to each other. The lenses LS1, LS2, . . . may be arranged in the first direction DR1. In an embodiment, the angle SAG may be 0°. In the case where the angle SAG is 0°, the long sides LS1s1, LS1s2, LS2s1, LS2s2, . . . of the lenses LS1, LS2, . . . may extend in the second direction DR2.

A lower surface (e.g., a surface facing the sub-pixels) of each of the lenses LS1, LS2, . . . may be partitioned into a plurality of viewpoint areas V1 to V39. The viewpoint areas V1 to V39 may be imaginary areas rather than being physically partitioned from each other, and may be defined in various ways depending on the resolution of the display panel DP, specifications of the lenses LS1, LS2, . . . , the number of viewpoints to be provided to the user, or the like. As each of the lenses LS1, LS2, . . . distributes images corresponding to the respective viewpoint areas V1 to V39 to different directions (e.g., different viewpoints), the user can see a multi-view image which varies depending on the location.

The sub-pixels SPX may overlap one or more of the viewpoint areas V1 to V39. For example, each of the sub-pixels SPX may be positioned corresponding to each of the viewpoint areas V1 to V39. The sub-pixels SPX that correspond to the same viewpoint area may display an image corresponding to the same viewpoint. For example, in FIG. 2, thirty-nine viewpoint areas V1 to V39 are present, so that the display panel DP may simultaneously display thirty-nine images.

In the display device 10, the sub-pixels SPX that overlap the viewpoint areas V1 to V20 may display a right-eye image, and the sub-pixels SPX that overlap the viewpoint areas V21 to V39 may display a left-eye image, whereby the display device can display a stereoscopic image. In this case, the user is needed to be located such that the left-eye image is visible to the left eye, and the right-eye image is visible to the right eye.

The sub-pixels SPX may be arranged in various arrangement structures such as an RGB-stripe structure, a diamond PENTILE™ structure (where PENTILE is an arrangement of luminous areas manufactured by SAMSUNG), a S-stripe structure, a real RGB structure, and a normal PENTILE™ structure.

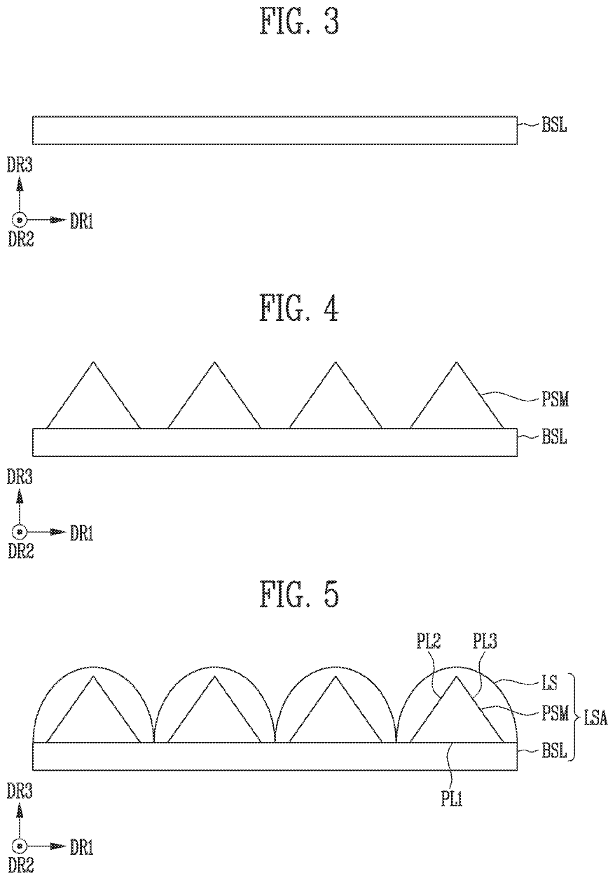

FIGS. 3 to 5 are diagrams illustrating a method of fabricating the lens array in accordance with an embodiment of the present disclosure.

First, referring to FIG. 3, a base substrate BSL may be prepared. The base substrate BSL may have a planar shape extending in the first direction DR1 and the second direction DR2 perpendicular to the first direction DR1. The base substrate BS may be formed of a transparent material. For example, the base substrate BSL may be formed of glass, plastic, metal, a liquid crystal layer, a polarizing film, or other materials.

Next, referring to FIG. 4, a plurality of prisms PSM may be formed on the base substrate BSL in such a way that the prisms PSM are arranged parallel to each other in the first direction DR1. A first surface (e.g., a lower surface also referred to as a “base”) of the prisms PSM may be in contact with an upper surface of the base substrate BSL. The prisms PSM may be formed of a transparent material. For example, the prisms PSM may be formed of glass, plastic, metal, a liquid crystal layer, a polarizing film, or other materials. In an embodiment, the prisms PSM may be formed of the same material as the base substrate BSL to have the same refractive index as the base substrate BSL.

In an embodiment, the prisms PSM may be formed through various well-known lithography processes or imprinting processes. As an example of the imprinting processes, first, thermoplastic resin or photocurable resin may be applied to the upper surface of the base substrate BSL. Thereafter, the resin may be pressed using a mold with a desired shape, and heat or ultraviolet light may be applied to the resin, thus forming the prisms PSM.

Subsequently, referring to FIG. 5, there may be formed a plurality of lenses LS that cover the prisms PSM and are arranged parallel to each other in the first direction DR1. A second surface PL2 and a third surface PL3 of each of the prisms PSM may be in contact with inner surfaces of a corresponding one of the lenses LS.

The lenses LS may be formed of a transparent material. For example, the lenses LS may be formed of glass, plastic, metal, a liquid crystal layer, a polarizing film, or other materials. In an embodiment, the lenses LS may be formed of a material that is different from that of the prisms PSM and the base substrate BSL to have a refractive index that is different from that of the prisms PSM and the base substrate BSL.

In an embodiment, the lenses LS may be formed through various well-known lithography processes or imprinting processes. As an example of the imprinting processes, first, thermoplastic resin or photocurable resin may be applied to the upper surface of the base substrate BSL and the prisms PSM. Thereafter, the resin may be pressed using a mold with a desired shape, and heat or ultraviolet light may be applied to the resin, thus forming the lenses LS.

The fabricated lens array LSA may include the base substrate BSL, the prisms PSM, and the lenses LS. The prisms PSM and the lenses LS may be arranged in the second direction different from the first direction DR1. Each of the lenses LS may have a shape, which is convex in the third direction DR3 perpendicular to the first direction DR1 and the second direction DR2. For example, each of the lenses LS may have a semi-cylindrical shape extending in the second direction DR2. For example, the first surface PL1, the second surface PL2, and the third surface PL3 may extend in the second direction DR2.

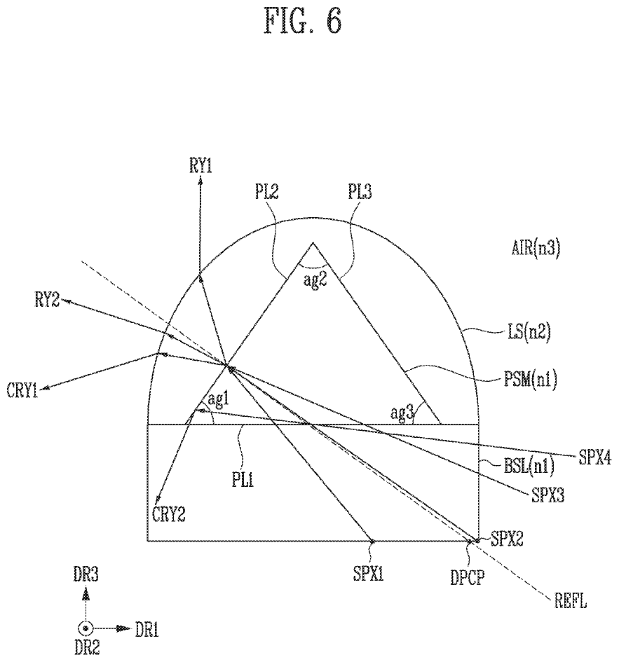

FIG. 6 is a diagram for describing effects of the lens array in accordance with an embodiment of the present disclosure. Referring to FIG. 6, there is illustrated an enlargement of a portion corresponding to one lens LS and one prism PSM of the lens array LSA.

In an embodiment, the base substrate BSL and the prisms PSM may have an identical first refractive index n1. For example, the first refractive index n1 may be 1.55 or more. For example, the first refractive index n1 may be 1.67. The lenses LS may have a second refractive index n2 that is less than the first refractive index n1. For example, the second refractive index n2 may be 1.5 or less. For instance, the second refractive index n2 may be 1.47. The second refractive index n2 may be greater than a third refractive index n3 equal to the refractive index of air. For example, the third refractive index n3 may be 1.

In FIG. 6, it is assumed that a reference line REFL is perpendicular to the second surface PL2 of the prism PSM. Hereinafter, there will be described as an example components of light passing through an intersection between the second surface PL2 and the reference line REFL among the components of light emitted from the first to fourth sub-pixels SPX1, SPX2, SPX3, and SPX4.

It is assumed that the first sub-pixel SPX1 and the second sub-pixel SPX2 are sub-pixels positioned in viewpoint areas corresponding to the lens LS of FIG. 6. For example, the first sub-pixel SPX1 and the second sub-pixel SPX2 may be positioned to overlap the lens LS of FIG. 6 in the third direction DR3. In an embodiment, it is desirable that rays RY1 and RY2 emitted from the first sub-pixel SPX1 and the second sub-pixel SPX2 be visible to the user as valid image components.

The first sub-pixel SPX1 may be positioned in a direction opposite to the first direction DR1 based on an intersection DPCP between the display panel DP and the reference line REFL. In accordance with the present embodiment, compared to the case where the prism PSM is not present, the ray RY1 emitted from the first sub-pixel SPX1 may be refracted to be closer to the third direction DR3 based on the relationship between the first, second, and third refractive indices n1, n2, and n3.

The second sub-pixel SPX2 may be positioned in the first direction DR1 based on the intersection DPCP. In accordance with the present embodiment, compared to the case where the prism PSM is not present, the ray RY2 emitted from the second sub-pixel SPX2 may be refracted to be closer to a direction opposite to the first direction DR1 based on the relationship between the first, second, and third refractive indices n1, n2, and n3. Therefore, compared to the case where the prism PSM is not present, the viewing angle at which the user can see an image may be expanded. For example, even though the user is not positioned exactly in front of lens LS in FIG. 6, the user may view the image through lens LS in FIG. 6.

It is assumed that the third sub-pixel SPX3 and the fourth sub-pixel SPX4 are sub-pixels positioned in viewpoint areas not corresponding to the lens LS of FIG. 6. For example, it is assumed that the third sub-pixel SPX3 and the fourth sub-pixel SPX4 are sub-pixels positioned in viewpoint areas corresponding to other lenses (e.g., adjacent lenses) rather than the lens LS in FIG. 6. For example, the third sub-pixel SPX3 and the fourth sub-pixel SPX4 may be positioned so as not to overlap the lens LS of FIG. 6 in the third direction DR3. In an embodiment, it is desirable that rays CRY1 and CRY2 emitted from the third sub-pixel SPX3 and the fourth sub-pixel SPX4 might not be visible to the user as crosstalk components.

The third sub-pixel SPX3 may be positioned in the first direction DR1 based on the intersection DPCP. The third sub-pixel SPX3 may be positioned on a side of the second sub-pixel SPX2 in the first direction DR1. In accordance with the present embodiment, compared to the case where the prism PSM is not present, the ray CRY1 emitted from the third sub-pixel SPX3 may be refracted to be closer to a direction opposite to the third direction DR3 based on the relationship between the first, second, and third refractive indices n1, n2, and n3. Therefore, the ray CRY1 corresponding to the crosstalk component might not be visible to the user.

The fourth sub-pixel SPX4 may be positioned in the first direction DR1 based on the intersection DPCP. The fourth sub-pixel SPX4 may be positioned on a side of the third sub-pixel SPX3 in the first direction DR1. In accordance with the present embodiment, compared to the case where the prism PSM is not present, the ray CRY2 emitted from the fourth sub-pixel SPX4 may be reflected to be closer to a direction opposite to the third direction DR3 based on the relationship between the first, second, and third refractive indices n1, n2, and n3. Therefore, the ray CRY2 corresponding to the crosstalk component might not be visible to the user.

Therefore, the lens array LSA, in accordance with the present embodiment, may have reduced crosstalk and an expanded viewing angle.

In an embodiment, internal angles ag1, ag2, and ag3 of the cross-section of each of the prisms PSM may be the same as each other. Here, the internal angles ag1, ag2, and ag3 may be set to be different from each other, whereby the characteristics of the lens array LSA such as the degree of crosstalk suppression, and the extent of viewing angle expansion can be adjusted. For example, in the case where the degree of crosstalk suppression and the extent of viewing angle expansion are required to be adjusted depending on a relative position of one lens LS based on the display panel DP, the internal angles ag1, ag2, and ag3 of the prisms PSM corresponding to the lens LS may be set to be different from each other.

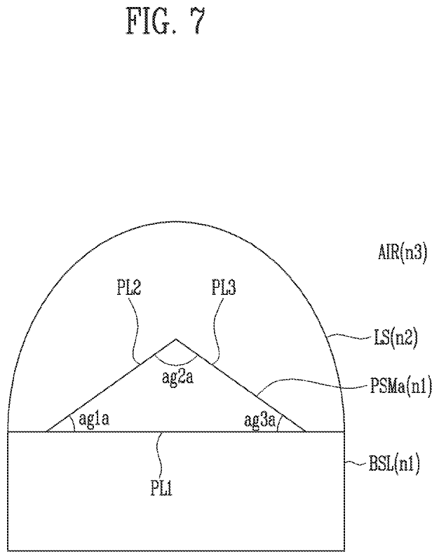

FIGS. 7 to 9 are diagrams for describing lens arrays in accordance with other embodiments of the present disclosure.

Referring to FIG. 7, among the internal angles ag1a, ag2a, and ag3a of the cross-section of each of the prisms PSMa, the internal angles ag1a and ag3a that abut the base substrate BSL may be less than the internal angle ag2a (at the apex) that does not abut the base substrate BSL. For example, each of the internal angles ag1a and ag3a that abut the base substrate BSL may have a value ranging from 20° to 45°.

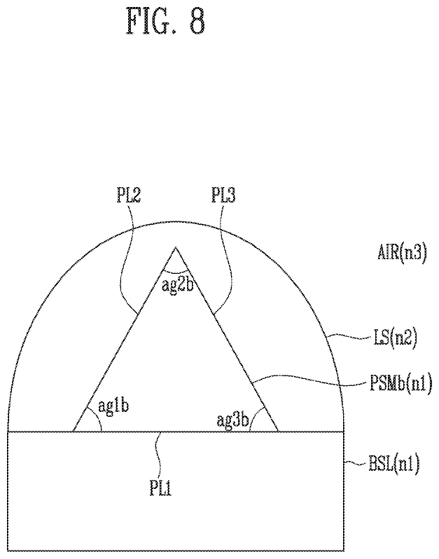

Referring to FIG. 8, among the internal angles ag1b, ag2b, and ag3b of the cross-section of each of the prisms PSMb, the internal angles ag1b and ag3b that abut the base substrate BSL may be greater than the internal angle ag2b (at the apex) that does not abut the base substrate BSL. As the internal angles ag1b and ag3b become larger, the effect of lateral light blocking may increase. For example, the crosstalk reduction performance may be enhanced.

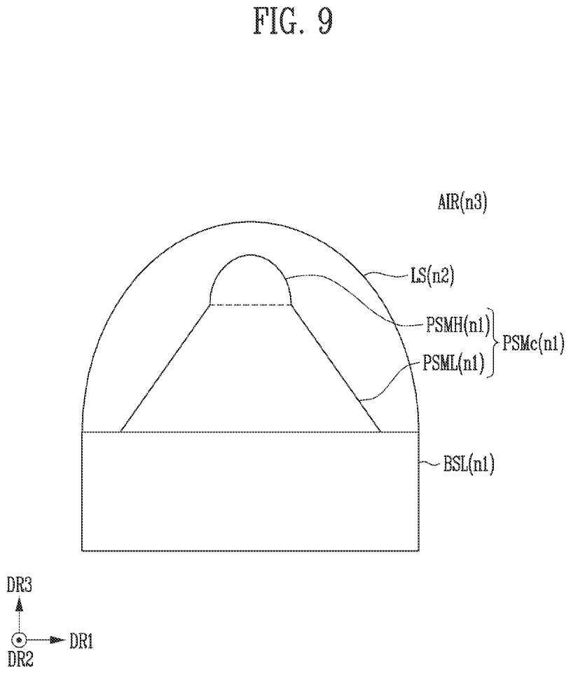

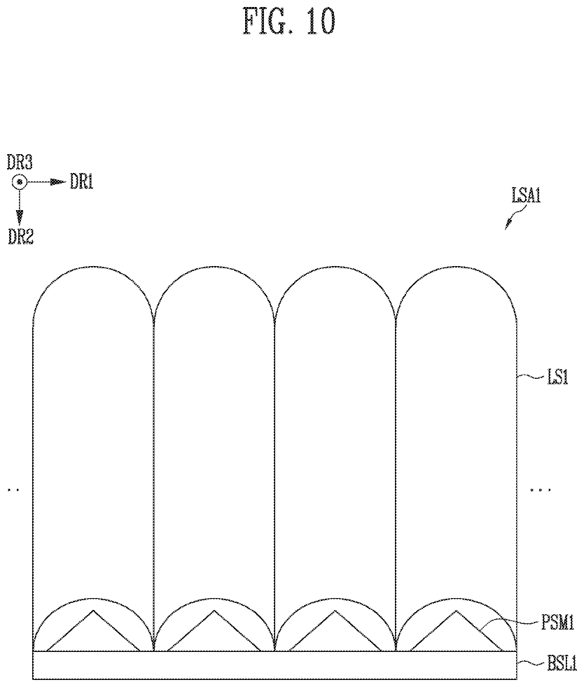

Referring to FIG. 9, among vertexes of each cross-section of a plurality of prisms PSMc, the vertex that does not abut the base substrate BSL (at the apex) may have a shape PSMH with a curvature. For example, the cross-section of each of the prisms PSMc may have a trapezoidal lower portion PSML (a trapezoidal base) and a semi-circular upper portion PSMH (a semi-circular apex). In accordance with an embodiment of FIG. 9, compared to the case of an angular vertex, frontal light scattering may be prevented.

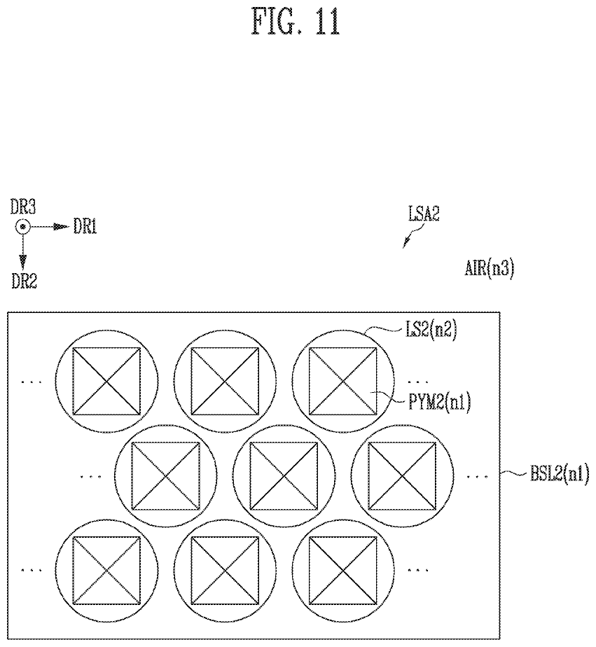

FIGS. 10 and 11 are diagrams for describing the case where the present disclosure is applied to different types of lens arrays.

FIG. 10 illustrates the case where a lens array LSA1 is a lenticular lens array, as described above. A base substrate BSL1 may correspond to the base substrate BSL. A plurality of prisms PSM1 may correspond to the prisms PSM. Lenses LS1 may correspond to the lenses LS. However, compared to the case of FIG. 2, FIG. 10 illustrates the case where the angle SAG is 0°.

FIG. 11 illustrates the case where the lens array LSA2 is a micro lens array. The lens array LSA2 may include a base substrate BSL2 having a planar shape extending in the first direction DR1 and the second direction DR2 perpendicular to the first direction DR1, a plurality of pyramids PYM2 positioned on the base substrate BSL2, and a plurality of lenses LS2 formed to cover the pyramids PYM2. Each of the lenses LS2 may have a convex lens, which protrudes in the third direction DR3.

A rectangular lower surface of each of the pyramids PYM2 may contact the base substrate BSL2. A vertex where triangular side surfaces of each of the pyramids PYM2 meet (the apex) may protrude in the third direction DR3 perpendicular to the first direction DR1 and the second direction DR2. In an embodiment, in the same manner as the case of FIG. 9, to prevent the frontal light scattering, the vertex where triangular side surfaces of each of the pyramids PYM2 meet (the apex) may have a curved shape with a certain degree of curvature.

A relationship between refractive indices n1, n2, and n3 may the same as the relationship between the refractive indices n1, n2, and n3 described with reference to FIG. 6. The base substrate BSL2 may correspond to the base substrate BSL. The pyramids PYM2 may correspond to the prisms PSM. The lenses LS2 may correspond to the lenses LS. For example, the base substrate BSL2 and the pyramids PYM2 may have the same first refractive index n1. The lenses LS2 may have the second refractive index n2 less than the first refractive index n1. The second refractive index n2 may be greater than the third refractive index n3 equal to the refractive index of air.

A fabrication method including the step of preparing the base substrate BSL2, the step of forming the pyramids PYM2, and the step of forming the lenses LS may be performed in the same manner as the fabrication method described in FIGS. 3 to 5, therefore, to the extent that an element is not described in detail with respect to this figure, it may be understood that the element is at least similar to a corresponding element that has been described elsewhere within the present disclosure.

In the case where the lens array LSA2 is a micro lens array, the user may see a multi-view image not only in a left-and-right direction (e.g., the first direction DR1) but also an up-and-down direction (e.g., the second direction DR2).

A lens array and a method of fabricating the lens array in accordance with the present disclosure may reduce crosstalk.

Although embodiments of the present disclosure have been disclosed for illustrative purposes, those skilled in the art will appreciate that various modifications, additions and substitutions are possible, without departing from the scope and spirit of the present disclosure. Accordingly, the bounds and scope of the present disclosure should not necessarily be limited by the embodiments disclosed in detail herein.

What is claimed is:

1. A lens array, comprising:
a base substrate;
a plurality of prisms arranged in parallel to each other in a first direction on the base substrate, each of the plurality of prisms extending in a second direction different from the first direction; and
a plurality of lenses covering the plurality of prisms, and arranged in parallel to each other in the first direction, each of the plurality of lenses extending in the second direction.

2. The lens array according to claim 1,
wherein a first surface of each of the plurality of prisms contacts an upper surface of the base substrate,
wherein a second surface and a third surface of each of the plurality of prisms contact inner surfaces of each of the plurality of lenses, and
wherein the first surface, the second surface, and the third surface extend in the second direction.

3. The lens array according to claim 1, wherein the base substrate and the plurality of prisms have an identical first refractive index.

4. The lens array according to claim 2, wherein the plurality of lenses have a second refractive index that is less than the first refractive index.

5. The lens array according to claim 3, wherein the second refractive index is greater than a third refractive index that is equal to a refractive index of air.

6. The lens array according to claim 1, wherein internal angles of a cross-section of each of the plurality of prisms are identical to each other.

7. The lens array according to claim 1, wherein, among internal angles of a cross-section of the plurality of prisms, the internal angle that abuts the base substrate is smaller than the internal angle that does not abut the base substrate.

8. The lens array according to claim 1, wherein, among internal angles of a cross-section of the plurality of prisms, the internal angle that abuts the base substrate is greater than the internal angle that does not abut the base substrate.

9. The lens array according to claim 1, wherein, an apex of each of the plurality of prisms has a curved shape.

10. The lens array according to claim 1, wherein a cross-section of each of the plurality of prisms includes a trapezoidal base, and a semi-circular apex.

11. A lens array, comprising:
a base substrate having a planar shape extending in a first direction and a second direction perpendicular to the first direction;
a plurality of pyramids disposed on the base substrate; and
a plurality of lenses, each of the plurality of lenses covering a corresponding pyramid of the plurality of pyramids.

12. The lens array according to claim 11,
wherein a rectangular base of each of the plurality of pyramids contacts the base substrate, and
wherein an apex of each of the plurality of pyramids protrudes in a third direction perpendicular to the first direction and the second direction.

13. The lens array according to claim 11, wherein the base substrate and the plurality of pyramids have an identical first refractive index.

14. The lens array according to claim 13, wherein the plurality of lenses have a second refractive index that is smaller than the first refractive index.

15. The lens array according to claim 14, wherein the second refractive index is greater than a third refractive index that is equal to a refractive index of air.

16. A method of fabricating a lens array, comprising:
preparing a base substrate;
forming a plurality of prisms arranged parallel to each other in a first direction on the base substrate, each of the plurality of prisms extending in a second direction different from the first direction; and
forming a plurality of lenses covering the plurality of prisms, and arranged parallel to each other in the first direction, each of the plurality of lenses extending in the second direction.

17. The method according to claim 16, wherein the base substrate and the plurality of prisms have an identical first refractive index.

18. The method according to claim 17, wherein the plurality of lenses have a second refractive index that is smaller than the first refractive index.

19. The method according to claim 18, wherein the second refractive index is greater than a third refractive index that is equal to a refractive index of air.

20. The method according to claim 16, wherein, among internal angles of a cross-section of the plurality of prisms, the internal angle that abuts the base substrate is less than the internal angle that does not about the base substrate.
